(19) United States
(12) Patent Application Publication
(10) Pub. No.: US 2016/0125163 A1
(43) Pub. Date: May 5, 2016

(54) APPARATUS FOR THE AUTOMATIC MANAGEMENT OF THE INTAKE OF DRUGS BY A PATIENT

(71) Applicant: Carlo Giuseppe BRIANZA, Milano (IT)

(72) Inventor: Carlo Giuseppe BRIANZA, Milano (IT)

(21) Appl. No.: 14/897,449

(22) PCT Filed: Jun. 12, 2014
(86) PCT No.: PCT/IB2014/062158

§ 371 Date: Dec. 10, 2015

(30) Foreign Application Priority Data
Jun. 12, 2013 (IT) FI2013A000142

(51) Int. Cl. G06F 19/00

(52) U.S. Cl. CPC G06F 19/3456; G06F 19/3418

(57) ABSTRACT

The present invention relates to a new apparatus capable of scheduling and supervising the intake of drugs by the patient. Said apparatus comprises a device adapted to be used by the patient as a reminder of the various administrations and the various drugs that the patient him/herself must take. The device according to the present invention is capable of automatically connecting to the Internet network—it only requires power supply—and is adapted to be set via remote connection directly by the patient's physician.

### FIELD OF THE INVENTION

The present invention relates to the technical field of apparatus used in the medical field, to assist the patient to carry out prescribed drug therapies.

### BACKGROUND ART

A very important problem in the medical field and in particular in the field of administration of drug therapies to be carried out not within a hospital scope but rather at home is related to the risk that the patient may forget to take his/her medication, or might take it in wrong doses, amounts and times.

This problem is especially felt in the case of elderly patients and of therapies including many drugs to be taken in different ways and times. In this case it is, unfortunately, very likely that the patient may make mistakes forgetting to take some drugs or may take them in the wrong way, with consequent risks to their health, risks which can be very serious. The above problem, of course, becomes even more serious when elderly patients live alone and need to organize their schedule for taking up their drugs by themselves.

The present invention introduces a new apparatus capable of solving the technical problem described above. Said apparatus comprises a device adapted to be used by the patient as a reminder of the various administrations and the various drugs that the patient him/herself must take.

The device according to the present invention is capable of automatically connecting to the Internet network—it only requires power supply—and is adapted to be set via remote connection directly by the patient's physician.

No type of action is required to the patient, the device according to the present invention does not require any settings by the user but only an initial setting by the installer. All information about the type of drug to be taken, the times and doses administered are entered remotely by the physician through access to a dedicated Internet portal connected to the device.

In response to said remote programming, the device according to the present invention provides to managing a series of reminders to be provided to the user when it is time to take a drug.

With the device according to the present invention, therefore, the user is both free from the risk of mistaking the times and mode of taking their drugs and from the difficulty of having to program the device him/herself, which can be difficult and even insurmountable for elderly or disabled users. The only action required by the user of the device according to the present invention is the pressure of a button, easily visible and accessible, to stop the reminder alarms, in the same way, for example, as what is done with a normal bedside alarm. If the above action of shutting down the reminder alarm is not performed within a specified period of time, the device according to the present invention is able to send an alert message through, for example, an SMS message to a reference preset mobile phone number, for example of the physician or a relative or a person able to verify if there are any emergencies and, if necessary, intervene to assist the patient or call for help. In a similar way, any kind of alert available may be used to this end: voice calls, instant messaging (i.e. text messages via the Internet), e-mail, etc. Moreover, advantageously, the device according to the present invention can verify the correct drug intake, that is, for example, the intake of the drug in the right amounts, even through the verification of any side effects that may occur after taking the drug, if the same drug was not taken in the right amounts or if it was taken in the presence of other drugs or still, if it shows poor tolerability by the user patient. To this end, the device according to the present invention may provide for, after a certain time of taking the drug, a series of further reminders to the user, this time relating to questions asked to the user him/herself and concerning the possible occurrence of side effects that may be indicative of incorrect intake or specific user incompatibility with the drug taken.

### BRIEF DESCRIPTION OF THE DRAWINGS

FIG. 1 shows a functional block diagram of the apparatus according to the present invention comprising an Internet server 10 and a device 11 provided with a user interface and means adapted to make connections to said Internet server.

FIG. 2 shows a functional block diagram of a first embodiment of device 11 according to the present invention.

FIG. 3 shows a functional block diagram of a second embodiment of device 11 according to the present invention.

### SUMMARY OF THE INVENTION

The present invention relates to a new apparatus capable of scheduling and supervising the intake of drugs by the patient. Said apparatus comprises a device adapted to be used by the patient as a reminder of the various administrations and the various drugs that the patient him/herself must take. The device according to the present invention is capable of automatically connecting to the Internet network—it only requires power supply—and is adapted to be set via remote connection directly by the patient's physician.

### DETAILED DESCRIPTION OF THE INVENTION

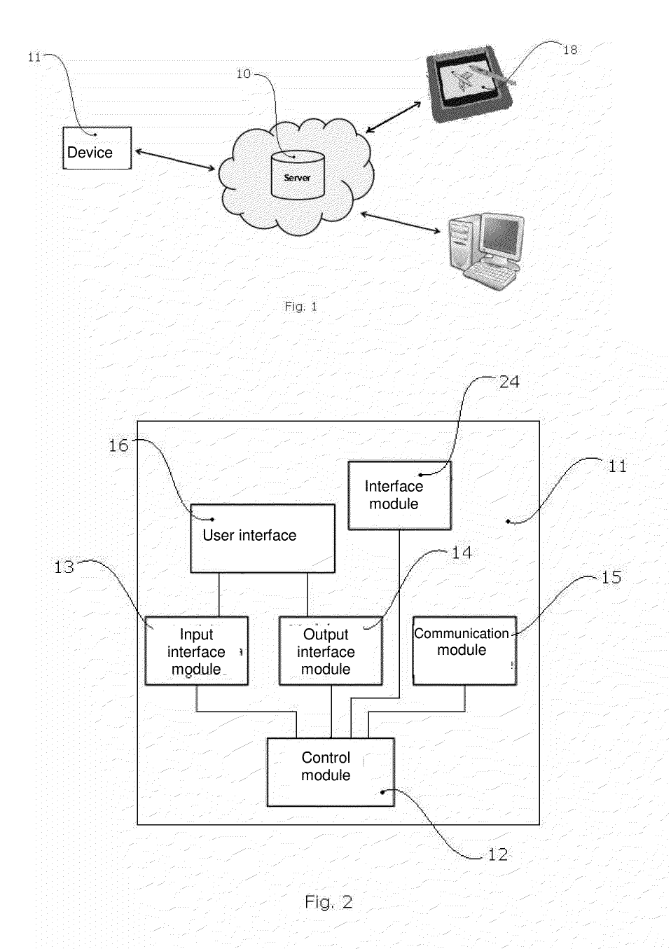

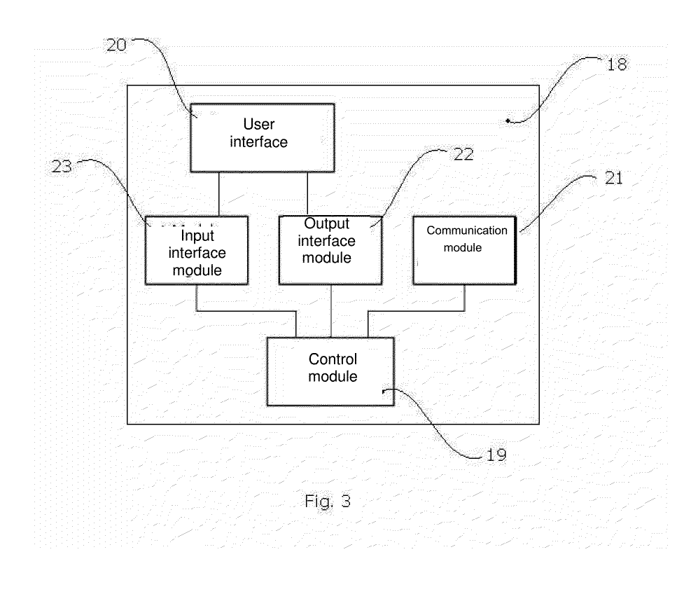

With reference to the accompanying FIGS. 1 and 2, the apparatus according to the present invention comprises the following components: an Internet server 10 and a device 11 provided with a user interface 16 and with means adapted to make connections to said Internet server 10.

In more detail, said device 11 comprises a control module 12 based on at least one microprocessor; an output interface module 13, associated with said user interface 16 and with said control module 12 and adapted to translate the settings made by a first local user (the patient) through said user interface 16 into controls for said control module 12; an input interface module 14, associated with said user interface 16 and with said control module 12 and adapted to translate the settings of a second remote user (the physician) made on said Internet server 10 into data and information for said user interface 16; a communication module 15, associated with said control module 12 and adapted to connect said device 11 to the Internet and communicate with said Internet server 10. Said communication module is adapted to establish a connection with said Internet server 10 in either wired or wireless mode according to the known communication protocols, Wi-Fi, Bluetooth, ZigBee, RFID/NFC, etc. or through the mobile phone network. Advantageously, said communication module 15 comprises a module for the connection with mobile phone networks of the TACS, GSM, GPRS, EDGE, UMTS, HSPA, etc. type comprising a SIM card with prepaid traffic, so as to allow the connection of said device 11 to the Internet even in cases in which the patient brings said device with him/her when he/she goes outside their own domestic environment.

Said input 13 and output 14 interface modules may optionally be integrated in said microprocessor.

Said user interface 16 preferably comprises a light alarm, a sound alarm and a display—adapted to provide said first local user with a reminder concerning the intake of a drug or the administration of a drug therapy—and a button or similar means, to stop the operation of such alarms. Additional buttons may be present, relative to additional features that will be explained hereafter.

Said control module 12 is adapted to send an alarm, through said communication module 15, if said first local user (the patient) does not act on said button or similar means to interrupt the operation of said alarms within a predetermined time.

Said alarm can be sent via, for example, an SMS message to a reference present mobile phone number, such as the physician or a relative or a person able to verify if there are any emergencies or dangerous situations and, in case, to intervene to assist the patient or call for help. In a similar way, any kind of alert available may be used to this end: voice calls, instant messaging (i.e. text messages via the Internet), e-mail, etc.

Preferably, said device 11 is small in shape and size so as to be easily placed wherever it is needed so as to be easily accessible and usable.

Said device 11 is further provided with suitable supply means comprising at least one non-rechargeable battery or a power supply optionally associated to at least one rechargeable battery.

Advantageously, moreover, said device 11 may comprise a further communication interface 24 adapted to control external actuators capable of operating external devices such as alarms, blinking lights, buzzers, or operating household systems such as the lighting system or the sound system, etc.

In a preferred embodiment of the present invention, said Internet server 10 is further associated with a web portal accessible online through suitable authentication and identification means, such as a user ID and a password, and adapted to provide said second remote user (the physician) with the possibility of connecting to said device 11 so as to set it with the settings related to said first local user: types of drugs to take, and intake amount, frequency and times.

In response to this setting, said device stores the settings given and schedules the alarms relating to said settings. In this way, when the time of intake of the drug by said first local user comes, said device 11 provides to actuate a reminder alarm to remind said first local user (the patient) to take the drug in question. The reminder alarm can be of the sound type (for example the activation of a ringer or a repeated recorded voice message) or visual type (for example the activation of a continuous or intermittent warning light) or a combination thereof. At the same time, the display of said device 11 will show the description of the drug to be taken with the relative amount and mode of intake.

At this point, the patient can follow the instructions of said device, take the drug according to the instructions shown on the display of said device and actuate said button, or similar means, to stop the operation of said sound and/or visual alarms. If this does not happen and said sound and/or visual alarms are not interrupted within a certain preset time interval, said device 11, through the action of said control module 12 and said communication module 15, can send an SMS message or forward a call to a preset phone number, for example, the telephone number of said first remote user, the patient's physician, or other person close to the patient him/herself and able to contact or go to the patient and possibly organize emergency first aid operations.

In addition to this basic feature, said device 11 is further adapted to count the drugs and treatments taken by the patient and store the data that are made available, via said Internet server 10, for future statistical processing. In addition, said device 11 can be further adapted to send to the pharmacy—automatically or upon actuation, by said first local user (the patient), of a dedicated button of said user interface 16—a purchase order of a drug identified as lacking or in shortage based on said count of the drugs and treatments taken by the patient. Submitting the order to the supplier can be done in different ways: online, through a web page or an e-mail message, or by sending an SMS message, or still by sending the order to a printer connected to said Internet server 10 or other possible methods defined on the basis of the needs of the pharmacy.

Moreover, advantageously, device 11 according to the present invention can verify the correct drug intake, that is, for example, the intake of the drug in the right amounts, even through the verification of the presence of any side effects that may occur after taking the drug, if the same drug was not taken in the right amounts. To this end, the device according to the present invention may provide for, after a certain time of taking the drug, a series of further alarms for the user, this time relating to questions asked to the user him/herself and concerning the possible occurrence of side effects that may also be indicative of incorrect intake or specific user incompatibility with the drug taken. Said questions can be asked to the user via a prerecorded audio message, for example emitted after a certain time interval from the drug intake and preferably preceded by a sound and/or light alarm identifiable by the user, or through a message displayed on the display of said device 11 and suitably announced by a sound and/or light alarm identifiable by the user. Said questions, moreover, will preferably be multiple and formulated in such a way to investigate, each, the occurrence of a single undesired side effect so as to allow closed and user selectable answers by the interaction with said at least one button, or similar means, of the user interface of device 11 according to the present invention.

In this case, the data related to the answers provided by the user can be conveniently stored and made available via said Internet server 10 for future statistical processing. These data can of course be of particular relevance in the analysis of the incidence of the side effects associated with taking certain drugs, alone or in combination with other drugs.

Device 11 according to the present invention is uniquely identified so as to be associated with a single specific local user.

Said Internet server 10 may be associated with a plurality of said devices 11 so that a single remote user, the treating physician, can interact, through said web portal associated with said Internet server 10, with a plurality of devices 11, each uniquely associated with a single, specific local user (the patient).

In a second preferred embodiment of the present invention, said Internet server 10 is associated with a second device 18 adapted to connect, through said Internet server 10, to at least one device 11 so as to interact therewith and allow said remote user to set said at least one device 11 with the settings related to said first local user (the patient): types of drugs to take, and intake amount, frequency and times, and to receive response data from said device 11 about the correct use thereof or to any problems related to failed intake of drugs by the patient.

Said second device 18 in turn comprises a control module 19 based on at least one microprocessor; a user interface 20; a communication module 21 adapted to communicate with said Internet server 10 so as to connect said device 18 to the Internet; an output interface module 22, associated with said user interface 20 and with said control module 19 and adapted to translate the settings of a second remote user (the physician) made on said user interface 20 into data and information to be sent, through said communication module 21, to said at least one device 11; an input interface module 23, associated with said user interface 20 and with said control module 19 and adapted to translate the data received from said at least one device 11 into information displayable on said user interface 20.

1. An apparatus for automatically managing of intake of drugs by a patient comprising an Internet server and a device comprising: a user interface for a first local user; means for the connection to said Internet server, adapted to receive the settings of a second remote user made on said Internet server and relating to directions about the intake of drugs for said first local user, and to the mobile phone network; data processing means adapted to: translating said settings into data and information for said user interface adapted to guide said first local user when taking said drugs, checking the interaction of said first local user with said user interface, sending alarms through said means for the connection to said Internet server and/or through said means for the connection to the mobile phone network if said interaction is not correct.

2. The apparatus according to claim 1, wherein said data processing means are further adapted to calculate the drugs and treatments taken by said first local user, store the related data and send, through said means for the connection to said Internet server and/or through said means for the connection to the mobile phone network, a purchase order of a drug the lack or shortage of which has been determined according to said calculation.

3. The apparatus according to claim 1, wherein said data processing means comprise a control module based on at least one microprocessor; an output interface module, associated with said user interface and with said control module and adapted to translate the settings made by said first local user through said user interface into controls for said control module; an input interface module, associated with said user interface and with said control module and adapted to translate the settings of said second remote user made on said Internet server into data and information for said user interface; said means for the connection to said Internet server and to the mobile phone network comprise a communication module, associated with said control module and adapted to connect said device to the Internet and communicate with said Internet server, and a module for the connection to mobile phone networks of the TACS, GSM, GPRS, EDGE, UMTS, HSPA type.

4. The apparatus according to claim 1, wherein said Internet server is further associated with a web portal accessible online through suitable authentication and identification means and adapted to provide said second remote user with the possibility of connecting to said device so as to set it with the settings related to said first local user: types of drugs to take, and intake amount, frequency and times.

5. The apparatus according to claim 1, wherein said Internet server is associated with a second device adapted to connect, through said Internet server, to at least one device so as to interact therewith and allow said remote user to set said at least one device with the settings related to said first local user: types of drugs to take, and intake amount, frequency and times, and to receive response data from said device about the correct use thereof or to any problems related to failed intake of drugs by the patient.

6. The apparatus according to claim 5, wherein said second device in turn comprises a control module based on at least one microprocessor; a user interface; a communication module adapted to communicate with said Internet server and connect said device to the Internet; an output interface module, associated with said user interface and with said control module and adapted to translate the settings of said second remote user made on said user interface into data and information to be sent, through said communication module, to said at least one device; an input interface module, associated with said user interface and with said control module and adapted to translate the data received from said at least one device into information displayable on said user interface.

7. The apparatus according to claim 3, wherein said input and output modules are integrated in said microprocessor of said control module.

8. The apparatus according to claim 1, wherein said user interface comprises a light alarm, a sound alarm and a display, adapted to provide said first local user with a reminder about the intake of a drug or the administration of a pharmacological therapy, a first button, or similar means, for interrupting the operation of said alarms and a second button, or similar means, for sending a purchase order of a drug the lack or shortage of which has been determined based on said calculation.

9. The apparatus according to claim 8, wherein said light alarm, said sound alarm and said display are further adapted to provide said first local user with an alert related to questions regarding the possible onset of side effects which may also indicate an incorrect intake or specific incompatibilities of the user with the drug taken, said alert comprising a prerecorded audio message or a graphical message displayed on said display.

10. The apparatus according to claim 9, wherein said audio or graphical alert is announced by a sound and/or light signal identifiable by the user.

11. The apparatus according to claim 3, wherein said control module is adapted to send an alarm, through said communication module, if said first local user does not act on said button or similar means to interrupt the operation of said alarms within a predetermined time.

12. The apparatus according to claim 11, wherein said alarm is selected from the group comprising: text messages to a preset reference mobile number, voice calls to a preset reference phone number, text messages over the Internet, emails.

13. The apparatus according to claim 1, wherein said device is provided with suitable supply means comprising at least one non-rechargeable battery or a power supply possibly associated with at least one rechargeable battery.

14. The apparatus according to claim 1, wherein said device comprises a further communication interface adapted to control external actuators capable of operating external devices such as alarms, blinking lights, buzzers, or of operating household systems such as the lighting system or the sound system.
